(19) United States
(12) Patent Application Publication
(10) Pub. No.: US 2020/0090361 A1
(43) Pub. Date: Mar. 19, 2020

(54) APPARATUS AND METHOD FOR MEASURING DIMENSION BASED ON 3D POINT CLOUD DATA

(71) Applicant: SAMIN E&S CO.,LTD., Busan (KR)

(72) Inventors: Deok Eun KIM, Busan (KR); Kyoung Wan KANG, Busan (KR)

(73) Assignee: SAMIN E&S CO.,LTD., Busan (KR)

(21) Appl. No.: 16/133,325

(22) Filed: Sep. 17, 2018

(51) Int. Cl. G06T 7/62; G06T 17/00

(52) U.S. Cl. CPC G06T 7/62; G06T 2207/10028; G06T 17/005

(57) ABSTRACT

An apparatus and a method for measuring a dimension based on a 3D point cloud data are provided to measure various dimensions for a target having a difficulty when the dimension of the target is measured using a measurement tool, such as a tape measure or a protractor. A method for measuring a dimension based on a three-dimensional (3D) point cloud data, includes receiving selection of a specific item from a dimension item list, acquiring 3D point cloud data for a target with respect to each continuous scene by scanning the target, setting a reference point for measuring the dimension whenever a marker displayed on a screen is selected during the scanning of the target, and calculating the dimension corresponding to the selected item, based on the 3D point cloud data, which is acquired during the scanning, and one or more reference points set during the scanning.

### BACKGROUND

Embodiments of the inventive concept described herein relate to an apparatus and a method for measuring a dimension based on a 3D point cloud data. More particularly, embodiments of the inventive concept described herein relate to an apparatus and a method for measuring a dimension on a 3D point cloud data, capable of measuring even various dimensions for a target, which cannot be measured using a measurement tool such as a tape measure, a protractor, or the like.

The measurement of various dimensions has been required in an industrial field or a living environment. In general, when the dimension of a target is measured, a measurement tool, such as a tape measure, a protractor, or the like, is used.

However, when a target has a curved line or a curved surface, when an obstacle or a space is present in targets, or when the target is formed in a three-dimensional (3D) space, there is limitation in measuring the dimension of the target only by using the measurement tool such as a tape measure, a protractor, or the like.

Accordingly, there is required a technology capable of measuring even various dimensions for a target, which cannot be measured using a measurement tool, such as a tape measure, a protractor, or the like, in an industrial fields or living environment.

### SUMMARY

Embodiments of the inventive concept provide an apparatus and a method for measuring a dimension based on 3D point cloud data, capable of measuring even various dimensions for a target, which cannot be measured using a measurement tool such as a tape measure, a protractor, or the like.

According to an aspect of an embodiment, a method for measuring a dimension based on a three-dimensional (3D) point cloud data, includes receiving selection of a specific item from a dimension item list, acquiring 3D point cloud data for a target with respect to each continuous scene by scanning the target, setting a reference point for measuring the dimension whenever a marker displayed on a screen is selected during the scanning of the target, and calculating the dimension corresponding to the selected item, based on the 3D point cloud data, which is acquired during the scanning, and one or more reference points set during the scanning.

The dimension item list includes at least one of a distance, a length, a diameter, an angle, an area, and a volume.

The calculating of the dimension includes creating one piece of 3D point cloud data by matching the 3D point cloud data for each scene in real time, extracting 3D point cloud data around each reference point from the matched 3D point cloud data, creating a shape based on the extracted 3D point cloud data, and calculating the dimension corresponding to the selected item, based on information of the created shape and information on 3D coordinates of the reference point.

The extracting of the 3D point cloud data around the reference point includes extracting 3D point cloud data positioned within a reference distance from the reference point by using a k-dimensional tree (k-d tree) when a capacity of the matched 3D point cloud data is equal to or greater than a reference capacity, and calculating a distance between each point of the matched 3D point cloud data and the reference point, and extracting points allowing calculated distances of the points to be within the reference distance, when the capacity of the 3D point cloud data is less than the reference capacity.

The creating of the shape includes creating the shape by using a random sample consensus algorithm (RANSC) or a least squares method algorithm.

The method further includes displaying the calculated dimension.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a view illustrating an outer appearance of an apparatus for measuring a dimension based on 3D point cloud data, according to an embodiment of the inventive concept;

FIG. 2 is a view illustrating the configuration of the apparatus for dimensioning the dimension based on the 3D point cloud data, according to an embodiment of the inventive concept;

FIG. 3 is a view illustrating the configuration of the controller illustrated in FIG. 2;

FIG. 4 is a view illustrating the structure of a pipe by way of example of the target disposed in a 3D space;

FIG. 5 is a view illustrating a procedure of measuring the dimension of the target illustrated in FIG. 4; and

FIG. 6 is a flowchart illustrating the method of measuring the dimension based on the 3D point cloud data, according to an embodiment of the inventive concept.

### DETAILED DESCRIPTION

Advantage points and features of the invention disclosure and a method of accomplishing thereof will become apparent from the following description with reference to the following figures, wherein embodiments will be described in detail with reference to the accompanying drawings. However, the inventive concept may be embodied in various different forms, and should not be construed as being limited only to the illustrated embodiments. Rather, these embodiments are provided as examples so that this disclosure will be thorough and complete, and will fully convey the concept of the inventive concept to those skilled in the art. The inventive concept may be defined by scope of the claims.

Unless otherwise defined, all terms (including technical and scientific terms) used herein have the same meaning as commonly understood by those skilled in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terms used in the inventive concept are provided for the illustrative purpose, but the inventive concept is not limited thereto. As used herein, the singular terms are intended to include the plural forms as well, unless the context clearly indicates otherwise. Furthermore, it will be further understood that the terms “comprises”, “comprising,” “includes” and/or “including”, when used herein, specify the presence of stated components, steps, operations, and/or devices, but do not preclude the presence or addition of one or more other components, steps, operations and/or devices.

Hereinafter, embodiments of the inventive concept will be described with reference to accompanying drawings. The same reference numerals will be assigned to the same components in drawings.

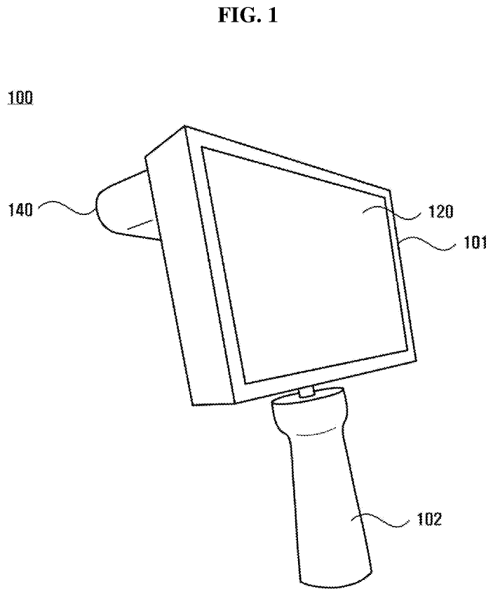

FIG. 1 is a view illustrating an outer appearance of an apparatus 100 for measuring a dimension based on 3D point cloud data, according to an embodiment of the inventive concept. Hereinafter, the apparatus 100 for measuring the dimension based on 3D point cloud data is referred to as “dimension measurement apparatus” for the convenience of explanation.

Referring to FIG. 1, the dimension measurement apparatus 100 may include a body 101 and a grip 102.

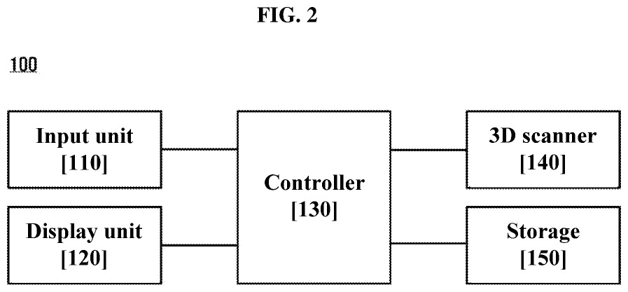

A display unit 120 (see FIG. 2) is disposed at one side of the body 101. A 3D scanner 140 (see FIG. 2) is disposed at an opposite side of the body 101. Various components of the dimension measurement apparatus 100 may be received inside the body 101. For example, a controller 130 and a storage 150 illustrated in FIG. 2 may be received inside the body 101.

The grip 102 is disposed at a lower portion of the body 101 and is mechanically coupled to the body 101. The body 101 may rotate at a specific angle in a specific direction about a coupling axis. A user may scan a target by moving the position of the dimension measurement apparatus 100 along the target while holding the grip 102 such that the 3D scanner 140 of the dimension measurement apparatus 100 faces the target.

FIG. 2 is a view illustrating the structure of the dimension measurement apparatus 100 illustrated in FIG. 1.

Referring to FIG. 2, according to an embodiment, the dimension measurement apparatus 100 includes an input unit 110, a display unit 120, a controller 130, a 3D scanner 140, and a storage 150.

The input unit 110 receives a command from a user. For example, the input unit 110 receives a power-on command, a scanning starting command, a scanning terminating command, a reference point setting command, and various selection commands. To this end, the input unit 110 may include at least one of a button, a keyboard, and a touch pad. In this case, the keyboard may be implemented in software or hardware.

The display unit 120 displays data or a result after processing a command. For example, the display unit 120 displays 3D point cloud data for a target. If the target is scanned, the 3D point cloud data is acquired with respect to each continuous scene. 3D point cloud data displayed on the display unit 120 may be 3D point cloud data for each scene or may be one piece of 3D point cloud data obtained by matching the 3D point cloud data for each scene. For another example, the display unit 120 displays a dimension item list. When a specific item is selected from the dimension item list and thus the dimension corresponding to the selected item is calculated, even the calculated dimension is displayed on the display unit 120. The display unit 120 may be implemented with an opaque display, a transparent display, a flat panel display, a flexible display, or the combination thereof.

According to an embodiment, the display unit 120 may be implemented separately from or integrally with the input unit 110 in hardware. For example, the touch screen may be obtained by integrating the display unit 120 with the input unit 110 in hardware. In this case, the user may input data or a command by touching or dragging the display unit 120. The following description will be made by way of example that the display unit 120 and the input unit 110 are integrated with each other in hardware.

The 3D scanner 140 acquires 3D point cloud data (PCD) on the surface of a target. The 3D point cloud data refers to numerous points constituting the surface of the target. Each of the points included in the 3D point cloud data includes 3D coordinates X, Y, and Z in which ‘Z’ refers to depth information. The 3D point cloud data may be obtained by scanning the target using the dimension measurement apparatus 100. When the target is scanned, the 3D point cloud data is acquired with respect to each continuous scene.

The 3D scanner 140 may acquire 3D point cloud data, for example, in a contactless scheme. The 3D scanner 140 employing the contactless scheme acquires the 3D point cloud data without being in contact with the target. The contactless scheme may include a Time Of Flight (TOF) scheme, an optical triangulation scheme, a white light scheme, and a structured light scheme by way of example.

The TOF scheme is a scheme of irradiating light onto the surface of the target, measuring a time taken when the irradiated light is reflected from the surfaces and received, and finding the distance between the target and an origin point for measurement. The 3D scanner 140 based on the TOF scheme may include a laser source to irradiate a laser beam onto the target and a camera to photograph the target irradiated with the laser beam

The 3D scanner 140 based on the optical triangulation scheme includes a laser source to irradiate a laser beam onto the target and a charge-coupled device (CCD) camera to receive the laser beam reflected from the surface of the target. When the laser beam collides with objects at mutually different distances from the laser source, the CCD camera to receive the laser beam shows that laser beams are at mutually different positions. Since the distance and the angle between the camera and the laser source are fixed and already known, the depth difference between the received laser beams may be calculated depending on the relative positions of the CCD device within the viewing angle of the camera, which is called the optical triangulation scheme.

The 3D scanner 140 based on the white light scheme projects a specific pattern to a target, photographs the deformed shape of the pattern, and acquires 3D point cloud data on the surface of the target. In this case, various types of patterns may be projected on the target. For example, one line, grid, or stripe pattern may be projected on the target. The 3D scanner 140 based on the white light scheme may simultaneously acquire 3D coordinates on the surfaces of all targets provided throughout the whole field of view (FOV).

The 3D scanner 140 based on the structured light scheme continuously irradiates light having different frequencies onto a target, detects a frequency difference when receiving the irradiated light through a light receiving unit, and calculates the distance between the 3D scanner 140 and the target.

The storage 150 stores an algorithm, program, or data required for the operation of the dimension measurement apparatus 100. For example, the storage 150 stores an algorithm necessary for the matching 3D point cloud data acquired for each continuous scene, an algorithm necessary for extracting specific 3D point cloud data from the matched 3D point cloud data, and an algorithm necessary for creating the shape based on the extracted 3D point cloud data.

In addition, the storage 150 stores data acquired in the procedure measuring the dimension. For example, the storage 150 stores multiple pieces of 3D point cloud data for scenes, which are acquired by scanning the target, 3D point cloud data, which is obtained by matching the multiple pieces of 3D point cloud data for the scenes with each other to be unified, and information of reference points set during the scanning. The storage 150 may include a non-volatile memory, a volatile memory, a hard disc drive (HDD), an optical disc drive (ODD), a magneto optic disk drive (MOD), a secure digital card (SD), or the combination thereof.

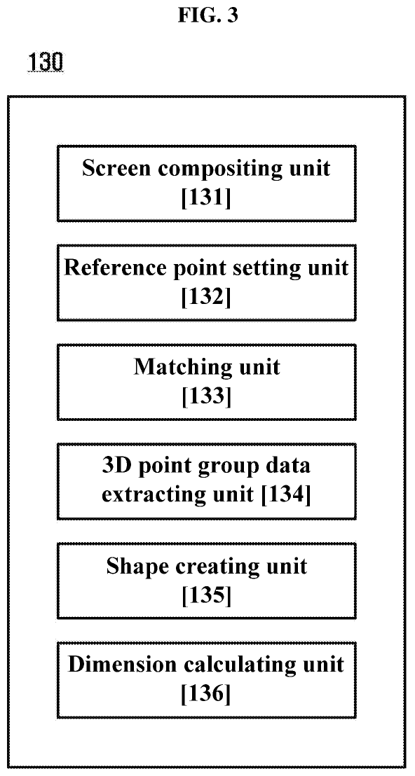

The controller 130 connects components of the dimension measurement apparatus 100 with each other and control the components. Hereinafter, the more detailed description of the controller 130 will be made with reference to FIG. 3.

Referring to FIG. 3, the controller 130 may include a screen compositing unit 131, a reference point setting unit 132, a matching unit 133, a 3D point cloud data extracting unit 134, a shape creating unit 135, and a dimension calculating unit 136.

The screen compositing unit 131 composites a screen related to dimension measurement and displays the composited screen on the display unit 120 when a dimension measurement application is executed. For example, the screen compositing unit 131 composites an initial screen including a dimension item list. The dimension items contained in the dimension item list may include a distance, a length, a diameter, an angle, an area, and a volume by way of example, but the inventive concept is limited thereto. When a specific item is selected from the dimension item list, the dimension item list, which is displayed on the screen, may be disappeared. Thereafter, when a specific area of the screen is touched, the screen compositing unit 131 displays a cross-shaped marker on the center of the screen. For example, the marker may be displayed when a certain area on the screen is touched. For another example, the marker may be displayed when an area corresponding to the target on the screen is touched. According to another embodiment, the marker may be always displayed on the center of the screen regardless of whether the screen is touched.

When the marker displayed on the center of the screen is selected during the scanning of the target, the reference point setting unit 132 sets the position of the selected marker as a reference point for dimension measurement. The marker may be selected several times during the scanning. In this case, the reference point setting unit 132 sets the position of the marker as the reference point whenever the marker is selected. In this case, the reference point setting unit 132 stores, in the storage 150, an index of a scene acquired at the time point at which the marker is selected and the 3D coordinates of the marker. The information of the reference point set by the reference point setting unit 132 is provided to the 3D point cloud data extracting unit 134 to be described.

The matching unit 133 matches 3D point cloud data acquired through the 3D scanner 140. In other words, the matching unit 133 creates one piece of 3D point cloud data by matching multiple pieces of 3D point cloud data acquired for continuous scenes in real time (real-time image stitch). The matched 3D point cloud data is provided to the 3D point cloud data extracting unit 134 to be described.

The 3D point cloud data extracting unit 134 extracts 3D point cloud data, which is positioned within a reference distance from the reference point set by the reference point setting unit 132, from the matched 3D point cloud data. If several reference points are set, the 3D point cloud data extracting unit 134 extracts 3D point cloud data positioned within the reference distance from each reference point, from the matched 3D point cloud data.

The 3D point cloud data extracting unit 134 determines whether the capacity of the matched 3D point cloud data is equal to or greater than a reference capacity to extract the 3D point cloud data, and determines a scheme of extracting the 3D point cloud data depending on the determination result.

In detail, when it is determined that the capacity of the matched 3D point cloud data is equal to or greater than the reference capacity, the 3D point cloud data extracting unit 134 may extract 3D point cloud data positioned within the reference distance from each reference point by using, for example, a k-dimensional tree (k-d tree) algorithm. The k-d tree is to expand a binary search tree to a multiple-dimensional space, and is a space-partitioning data structure for including points in the space in a k-dimension. When the k-d tree is used, points near a predetermined point may be rapidly searched in points positioned in the k-d space. Since the k-d tree algorithm is well-known in the art, the details thereof will be omitted below.

If the capacity of the matched 3D point cloud data is determined to be less than the reference capacity, the 3D point cloud data extracting unit 134 calculates the distance to the reference point from each point of the matched 3D point cloud data. In addition, the 3D point cloud data extracting unit 134 extracts points allowing calculated distances of the points to be within the reference distance.

The shape creating unit 135 creates a shape based on the 3D point cloud data extracted from the 3D point cloud data extracting unit 134. For example, the shape creating unit 135 creates a plane, a sphere, a cylinder, or the like.

According to an embodiment, the shape creating unit 135 may employ a random sample consensus (RANSAC) algorithm to create the shape based on the 3D point cloud data. The RANSAC algorithm refers to a scheme to select an arbitrary solution, to evaluate the consensus between the solution and input data, and to select a solution having the highest consensus with the input data. The RANSAC algorithm supplements the disadvantages of Least Squares Method (LSM). Since the k-d tree algorithm is well-known in the art, the details thereof will be omitted below.

According to another embodiment, the shape creating unit 135 may employ LSM to create the shape based on the 3D point cloud data. The LSM is a method to find a parameter of a model capable of sufficiently expressing a certain data distribution. The LSM calculates a parameter to minimize the sum of the squares of errors between the model and the data. Since the k-d tree algorithm is well-known in the art, the details thereof will be omitted below.

The dimension calculating unit 136 calculates a dimension corresponding to the item selected from the dimension item list, based on the information of the shape created by the shape creating unit 135. The calculated dimension displays through the display unit 120. When the dimension measurement apparatus 100 includes an output unit, for example, a speaker in addition to the display unit 120, the calculated dimension may be output through the speaker.

The screen compositing unit 131, the reference point setting unit 132, the matching unit 133, the 3D point cloud data extracting unit 134, the shape creating unit 135, and the dimension calculating unit 136 may be implemented through one software application.

The above description has been made with reference to FIGS. 1 to 3 in terms of the outer appearance and the configuration of the dimension measurement apparatus 100 according to the embodiment. Although FIG. 1 illustrates the case that the dimension measurement apparatus 100 includes the body 101 and the grip 102, the outer appearance of the dimension measurement apparatus 100 may be varied. For example, the position and/or the shape of the grip 102 may be varied or omitted.

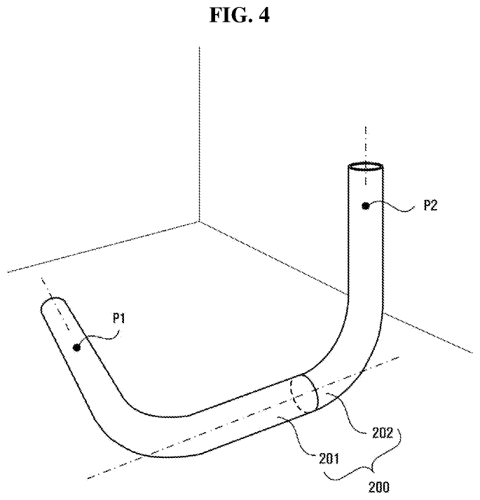

The dimension measurement apparatus 100 may include a communication device equipped with a scanning sensor. The communication device may be a smart phone and a tablet personal computer (PC) by way of example. However, the communication device is not limited to the example. In other words, as long as a communication device is equipped with a scanning sensor to acquire the 3D point cloud data, it may be understood that the communication device is included in the dimension measurement apparatus 100. FIG. 4 is a view illustrating a pipe structure 200 serving as a target disposed in the 3D space.

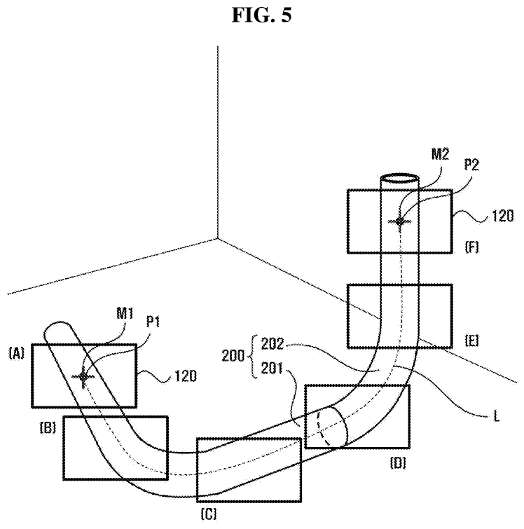

It may be understood from FIG. 4 that the pipe structure 200 is formed in a 3D structure by welding a first pipe in a bent shape and a second pipe 202 in a bent shape. As illustrated in FIG. 4, there is limitation in measuring the length or the angle of the pipe structure 200 having the 3D structure by using a measurement tool such as a tape measure or a protractor. However, when the dimension measurement apparatus 100 is used according to an embodiment of the inventive concept, the dimension, such as the length or the angle, may be measured with respect to even the pipe structure 200. Hereinafter, the procedure of measuring the dimension of the pipe structure 200 using the dimension measurement apparatus 100 will be described with reference to FIG. 5.

When an initial screen including the dimension item list is displayed on the display unit 120, the user selects a desired item from the displayed dimension items. The dimension items may include a distance, a length, a diameter, an angle, an area, and a volume. If a specific item is selected from the dimension item list, the information on the number of the reference points necessary for calculating the dimension of the selected item is displayed on the screen. For example, the angle refers to the spread degree between two lines branching from one point. Accordingly, to calculate the angle, at least two reference points have to be set. Therefore, the display unit 120 may display a guide statement of “two reference points have to be set during scanning”.

When the user inputs a scanning execution command by handling the input unit 110, the function of the 3D scanner 140 is activated, and the 3D scanner 140 starts acquiring 3D point cloud data on the surface of the pipe structure 200.

Thereafter, when the user touches a specific area on the screen, a first marker M1 having a cross shape is displayed on the center of the screen. The first marker M1 may be displayed when the specific area of the screen is displayed or when an area of the screen, which corresponds to the pipe structure 200, is touched.

If the first marker M1 is displayed on the screen, the user positions the first maker M1 having the cross shape on a first position P1 of a first pipe 201 by moving the dimension measurement apparatus 100 as illustrated in reference sign of FIG. 5. Next, the user touches the first marker M1 to set the first reference point. In detail, when the first marker M1 is touched, the dimension measurement apparatus 100 sets the position of the touched marker as a first reference point for dimension measurement. In this case, the dimension measurement apparatus 100 stores, in the storage 150, an index of a scene touched at the time point when the first marker M1 is touched and 3D coordinates of the first marker M1. Accordingly, when the setting of the first reference point is completed, the first maker M1 may be disappeared from the screen.

Therefore, as illustrated in reference signs [B], [C], [D], and [E] of FIG. 5, the user continuously scans the pipe structure 200 by moving the dimension measurement apparatus 100 along the first pipe 201 and the second pipe 202.

Thereafter, when the user touches a specific area of the screen, a second marker M2 having a cross shape is displayed on the center of the screen. The second marker M2 is distinguished from the first marker M1 as described above for the convenience of explanation, and substantially the same as the first marker M1.

When the second marker M2 is displayed on the screen, the user positions the second marker M2 to the second position P2 of the second pipe 202 by moving the dimension measurement apparatus 100 as illustrated in reference sign [F] of FIG. 5. Next, the user touches the second marker M2 to set the second reference point. In detail, when the second marker M2 is touched, the dimension measurement apparatus 100 sets the position of the touched marker as a second reference point for dimension measurement. In this case, the dimension measurement apparatus 100 stores, in the storage 150, an index of a scene acquired at the time point when the first marker M2 is touched and 3D coordinates of the second marker M2. When the setting of the second reference point is completed, the second marker M2 may be disappeared from the screen.

When the setting of the reference point is completed, the angle between the first pipe 201 and the second pipe 202 is calculated based on the first reference point and the second reference point set during the scanning. The calculated angle value is displayed on the display unit 120.

In more detail, as illustrated in reference signs [A] to [F], when the pipe structure 200 is scanned, 3D point cloud data is acquired for each continuous scene. The dimension measurement apparatus 100 matches multiple pieces of 3D point cloud data for sense with each other in real time to create one piece of 3D point cloud data. Then, 3D point cloud data (hereinafter, referred to as “first point cloud data”), which is positioned within a reference distance from the first reference point, is extracted from the matched 3D point cloud data. Simultaneously, 3D point cloud data (hereinafter, referred to as “second point cloud data”), which is positioned within a reference distance from the second reference point, is extracted from the matched 3D point cloud data.

Thereafter, the dimension measurement apparatus 100 creates a first shape based on the first point cloud data and a second shape based on the second point data. The first shape and the second shape may be a cylindrical shape. When the first shape and the second shape are extracted, the dimension measurement apparatus 100 acquires the central line (hereinafter, referred to as ‘the first central line’) of the first shape and the central line (hereinafter, referred to as ‘the second central line’) of the second shape. Next, the dimension measurement apparatus 100 calculates the angle between two acquired central lines. The calculated value is displayed on the display unit 120.

Thereafter, when the user inputs a scanning terminating command by handling the input unit 110, the function of the 3D scanner 140 is deactivated and the acquisition of the 3D point cloud data is terminated.

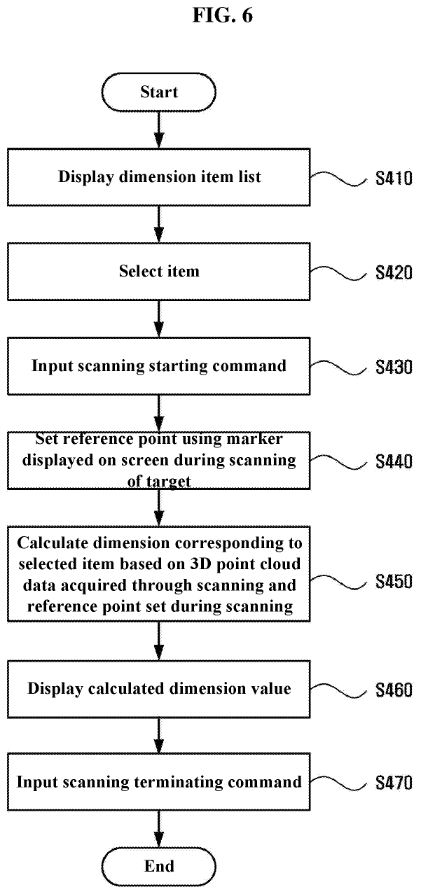

FIG. 6 is a flowchart illustrating a method of measuring a dimension based on the 3D point cloud data, according to an embodiment of the inventive concept.

First, the dimension measurement apparatus 100 displays A dimension item list (S410). Dimension items may include a distance, a length, a diameter, an angle, an area, and a volume.

If a specific item is selected from the dimension item list (S420), the dimension measurement apparatus 100 calculates the dimension of the selected item and displays, on the display unit 120, the information on a reference point necessary for calculating the dimension of the selected item.

Thereafter, when a scanning starting command is inputs (S430), the 3D point cloud data on the surface of the target is started to be acquired.

Then, a reference point is set by using a maker displayed on the screen during the scanning of a target (S440). The step S440 may include the steps of displaying a marker on the center of the screen when a specific area on the screen is touched, of setting the reference point whenever the displayed marker is selected, and of releasing the display of the marker when the reference point is set. In addition, the setting of the reference point whenever the displayed marker is selected may include the steps of storing an index of a scene acquired at the time point that the marker is selected, and of storing 3D coordinates of the marker.

When the setting of the reference point is completed, the dimension measurement apparatus 100 calculates the dimension corresponding to the selected item, based on the 3D point cloud data acquired during the scanning and at least one reference point set during the scanning (S450). The step S450 includes the steps of creating one piece of 3D point cloud data by matching the 3D point cloud data acquired for each scene during the scanning in real time, extracting 3D point cloud data, which is positioned within the reference distance from each reference point, from the matched 3D point cloud data, creating the shape from the extracted 3D point cloud data, and calculating the dimension corresponding to the selected item based on the information of the created shape and 3D coordinates of each reference point.

The dimension value calculated in step S450 is displayed on the display unit 120 (S460).

Thereafter, if the scanning terminating command is input (S470), the operation of acquiring the 3D point cloud data for the target is terminated.

The above description has been made with reference to FIG. 6 regarding the method for measuring the dimension according to an embodiment. The order of the steps illustrated in FIG. 6 may be changed. The step S470 of inputting the scanning terminating command may be performed next to the step S440 of setting the reference point. In this case, even if the setting of the reference point is completed, only if the scanning terminating command is input, the dimension calculating step (S450) may be performed.

As described above, when the dimension of the target is measured, even the dimension of the target, which cannot be measured using a measure tool such as a tape measure, a protractor, or the like.

A user can simply carry the measurement apparatus because the measurement apparatus did not need to be connected with additional equipment, such as a notebook computer.

According to the related art, if 3D point cloud data acquired for each scene is matched and displayed on a screen, a user has to enlarge or rotate point cloud data to select a reference point. Accordingly, the user is bothered with selecting the reference point, and it is difficult for the user to select the position of the reference point. In contrast, according to the technology of the inventive concept, the reference point may be set during the scanning of the target, so the user convenience can be improved. In addition, since the reference point can be set using n the marker displayed on the center of the screen, the position of the reference point can be more exactly set when compared with the related art.

Embodiments of the inventive concept may be realized with a medium, such as a computer-readable medium, including a computer-readable code/command for controlling at least one processing component of the above-described embodiments. The medium may correspond to a medium/media enabling the storage and/or the transfer of the computer-readable code.

The computer-readable code may be not only recorded in a medium, but also transferred through the Internet. The medium may include, for example, a recording medium, such as a magnetic storage medium (e.g., a read only memory (ROM), a floppy disk, a hard disk, or the like) and an optical recording medium (e.g., a CD-ROM, a Blu-Ray, a DVD, or the like) and a transfer medium such as a carrier wave. Since the media may be provided in the form of a distributed network, the computer-readable code may be stored/transferred and executed in a distributed manner. Further, as one example, processing components may include a processor or a computer processor and may be distributed and/or included in one device.

Although embodiments of the inventive concept have been described with reference to accompanying drawings, those skilled in the art should understand that various modifications are possible without departing from the technical scope of the inventive concept or without changing the technical sprite or the subject matter of the inventive concept. Therefore, those skilled in the art should understand that the technical embodiments are provided for the illustrative purpose in all aspects and the inventive concept is not limited thereto.

What is claimed is:

1. A method for measuring a dimension based on a three-dimensional (3D) point cloud data, the method comprising:
receiving selection of a specific item from a dimension item list;
acquiring 3D point cloud data for a target with respect to each continuous scene by scanning the target;
setting a reference point for measuring the dimension whenever a marker displayed on a screen is selected during the scanning of the target; and
calculating the dimension corresponding to the selected item, based on the 3D point cloud data, which is acquired during the scanning, and one or more reference points set during the scanning.

2. The method of claim 1, wherein the dimension item list includes at least one of a distance, a length, a diameter, an angle, an area, and a volume.

3. The method of claim 1, wherein the calculating of the dimension includes:
creating one piece of 3D point cloud data by matching the 3D point cloud data for each scene in real time;
extracting 3D point cloud data around each reference point from the matched 3D point cloud data;
creating a shape based on the extracted 3D point cloud data; and
calculating the dimension corresponding to the selected item, based on information of the created shape and information on 3D coordinates of the reference point.

4. The method of claim 3, wherein the extracting of the 3D point cloud data around the reference point includes:
extracting 3D point cloud data positioned within a reference distance from the reference point by using a k-dimensional tree (k-d tree) when a capacity of the matched 3D point cloud data is equal to or greater than a reference capacity; and
calculating a distance between each point of the matched 3D point cloud data and the reference point, and extracting points allowing calculated distances of the points to be within the reference distance, when the capacity of the 3D point cloud data is less than the reference capacity.

5. The method of claim 3, wherein the creating of the shape includes:
creating the shape by using a random sample consensus algorithm (RANSC) or a least squares method algorithm.

6. The method of claim 1, further comprising:
displaying the calculated dimension.

7. An apparatus for measuring a dimension based on 3D point cloud data, the apparatus comprising:
a 3D point cloud data acquiring unit configured to acquire 3D point cloud data for a target with respect to each continuous scene by scanning the target;
a reference point setting unit configured to set a reference point for measuring the dimension whenever a marker displayed on a screen is selected during the scanning of the target; and
a dimension calculating unit configured to calculate the dimension corresponding to an item selected from a dimension item list, based on the 3D point cloud data, which is acquired during the scanning, and one or more reference points set during the scanning.

8. The apparatus of claim 7, wherein the dimension item list includes at least one of a distance, a length, a diameter, an angle, an area, and a volume.

9. The apparatus of claim 7, further comprising
a matching unit configured to create one piece of 3D point cloud data by matching the 3D point cloud data for each scene in real time;
a 3D point cloud data extracting unit configured to extract 3D point cloud data positioned within a reference distance from each reference point from the matched 3D point cloud data; and
a shape extracting unit configured to create a shape based on the extracted 3D point cloud data.

10. The apparatus of claim 8, wherein the dimension calculating unit calculates:
the dimension corresponding to the selected item, based on information of the created shape and information on 3D coordinates of the reference point.

11. The apparatus of claim 7, further comprising:
a display unit configured to display the calculated dimension.
